(19) United States
(12) Patent Application Publication
(10) Pub. No.: US 2012/0040853 A1
(43) Pub. Date: Feb. 16, 2012

(54) REAL TIME MULTIPLEX PCR DETECTION ON SOLID SURFACES USING DOUBLE STRANDED NUCLEIC ACID SPECIFIC DYES

(75) Inventors: Anke Pierik, Eindhoven (NL); Derk Jan Wilfred Klunder, Eindhoven (NL); Marius Losif Boamfa, Eindhoven (NL); Richard Joseph Marinus Schroedes, Eindhoven (NL); Hendrik Roelof Stapert, Eindhoven (NL); Danielle Elisa Willemine Clout, Eindhoven (NL)

(73) Assignee: KONINKLIJKE PHILIPS ELECTRONICS N.V., EINDHOVEN (NL)

(21) Appl. No.: 13/131,333

(22) PCT Filed: Nov. 17, 2009
(86) PCT No.: PCT/IB2009/055119

§ 371 Date: May 26, 2011

(30) Foreign Application Priority Data
Nov. 21, 2008 (EP) 08169667.6

(51) Int. Cl. C40B 30/04

(52) U.S. Cl. 506/9

(57) ABSTRACT

The present invention provides method allowing for real time detection of a multitude of target nucleic acids of interest in one reaction (multiplexing) using dyes that are specific for double stranded nucleic acids.

### FIELD OF THE INVENTION

The present invention provides method allowing for real time detection of a multitude of target nucleic acids of interest in one reaction (multiplexing) using dyes that are specific for double stranded nucleic acids.

### BACKGROUND OF THE INVENTION

Techniques for the detection and amplification of extremely small quantities of nucleic acid are an indispensable tool in modern molecular biology and biochemical research and are e.g. used for the diagnosis and detection of diseases, in forensic science, DNA sequencing and recombinant DNA technology.

The use of the polymerase chain reaction (PCR) offers a fast and convenient method of amplifying a specific nucleic acid sequence. The technique is based on the replication of nucleic acids using a thermostable DNA-Polymerase.

A basic PCR setup requires several components and reagents. A denatured nucleic acid sample is incubated with DNA polymerase, nucleotides and two oligonucleotide primers, which are chosen such that they flank the fragment to be amplified so that they direct the DNA polymerase to synthesize new complementary strands.

PCR methods commonly involve thermal cycling, i.e., alternately heating and cooling the PCR sample to a defined series of temperature steps. Most commonly PCR is carried out with 20-40 cycles each having 3 different temperature steps. In a first step the reaction is heated (e.g. to 94-98° C.) in order to melt the nucleic acid template by disrupting the hydrogen bonds between complementary bases of the nucleic acid strands (denaturation step). Next the reaction temperature is lowered to a temperature that corresponds to the melting temperature of the primers used (e.g. 50° to 65° C.) in order to allow annealing of the primers to their complementary sequences on the single stranded nucleic acid template (annealing step). In the third step the DNA polymerase synthesizes a new nucleic acid strand by adding nucleotides that are complementary to the template in 5′ to 3′ direction (elongation step; e.g. carried out at 72° C.). As PCR progresses, the nucleic acid thus generated is itself used as a template for replication. This causes a chain reaction in which the nucleic acid template is exponentially amplified. Approximately 20 cycles of PCR amplification increase the amount of the target sequence around one-million fold with high specificity. However, this PCR method is at best semi-quantitative and, in many cases, the amount of product is not related to the amount of input target nucleic acid.

For some applications, for example diagnostic methods or gene expression studies, it is however desirable to monitor the increase in the amount of nucleic acid as it is amplified. This can be achieved by a quantitative PCR method that has been introduced fairly recently and which is referred to as “real-time PCR”. The procedure follows the general principle of polymerase chain reaction, with the amplified nucleic acid being quantified in real time as it accumulates in the reaction at the respective PCR cycles. The quantification is usually based on fluorescent measurements. An increase in nucleic acid product during PCR thus leads to an increase in fluorescence intensity and is measured at a given number of cycles or at each cycle, thus allowing nucleic acid concentrations to be quantified.

Concentrations of nucleic acid present during the exponential phase of the PCR reaction can e.g. be detected by plotting fluorescence against cycle number on a logarithmic scale. Amounts of nucleic acid can then be determined by comparing the results to a standard curve produced by real time PCR of serial dilutions of a known amount of nucleic acid. Relative concentrations of nucleic acid present during the exponential phase can e.g. also be calculated by determining a threshold for detection of fluorescence above background and calculating relative amounts of nucleic acid based on the cycle threshold of the sample.

Typically the above described real time PCR method is carried out in solution.

One disadvantage of conventional real time PCR is that cannot easily be applied to the detection of multiple nucleic acids in parallel (multiplexing), as different non-overlapping fluorescent dyes have to be used for different target nucleic acids. Multiplexing of real time PCR approaches may be achieved by performing the multiplex PCR and then detecting the amplified targets on an array. However, performing multiplex PCR and detection on a array have their own problems which in part result from background signals that impede proper signal allocation.

Therefore, there is a continuing need in the art to develop novel methods that allow for multiplex real time PCR detection.

### OBJECT AND SUMMARY OF THE INVENTION

It is therefore an objective of the present invention to provide a simple and efficient method for simultaneously monitoring the amplification of one or more target nucleic acids.

It is another objective of the present invention to provide a simple and efficient method for simultaneously monitoring the amplification of one or more target nucleic acids under real time conditions.

These and other objectives as they will become apparent from the ensuing description and claims are attained by the subject matter of the independent claims. Some of the preferred embodiments are defined by the dependent claims.

In a first aspect the present invention relates to a method for monitoring the amplification of one or more target nucleic acids comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers
d. Hybridizing the denatured one or more target nucleic acids of step c.i. with the nucleic acids capture probes optionally concomitantly with the elongation step c.ii.;
e. Detecting hybridization of said one or more amplified target nucleic acids with said capture probes by determining a signal generated from the at least one dye that is capable of specifically interacting with double stranded nucleic acids.

In a second aspect which may be preferred, the present invention relates to a Method according to claim 1 comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers;
d. Determining the concentration of the amplified target nucleic acids in the sample;
e. Hybridizing the denatured one or more target nucleic acids of step c.i. with the nucleic acids capture probes optionally concomitantly with the elongation step c.ii.;
f. Detecting hybridization of said one or more amplified target nucleic acids of step c. with said capture probes by determining a signal generated from the at least one dye that is capable of specifically interacting with double stranded nucleic acids.

In a third aspect which may be even more preferred, the present invention relates to a method according to claim 1 comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Adding to said sample a double stranded nucleic acid of known identity and further reagents required for nucleic acid amplification in a polymerase chain reaction including forward and reverse primers and a control probe which allows fluorescent detection at wavelengths different from the dye that is capable of specifically interacting with double stranded nucleic acids, with the primers and the control probe being specific for said double stranded nucleic acid of known identity;
d. Amplifying the one or more target nucleic acids by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers;
e. Determining the concentration of the amplified target nucleic acids in the sample;
f. Hybridizing the denatured one or more target nucleic acids of step d.i. with the nucleic acids capture probes optionally concomitantly with the elongation step d.ii.;
g. Detecting hybridization of said one or more amplified target nucleic acids of step d. with said capture probes by determining a signal generated from the at least one dye that is capable of specifically interacting with double stranded nucleic acids.

In a preferred embodiment, determining the concentration of the amplified target nucleic acids in the sample according to step (d) of the second and step (e) of the third aspect is done by measuring the signal generated from dyes capable of specifically interacting with double stranded nucleic acids that have bound to the amplified target nucleic acids. Determining the concentration may include recording of a calibration curve that result from conducting the methods of the second and third aspect with the known target nucleic acids of defined concentration.

In another preferred embodiment, detecting hybridization of amplified target nucleic acids with capture probes may be undertaken only if determining the concentration of the amplified target nucleic acid sequences in step d. of the second and third aspect a reveals that the concentration of amplified target nucleic acids has in the sample increased above the detection limit for detecting hybridization.

In a preferred embodiment of this latter application of the present invention, detecting hybridization is undertaken if determining the concentration of the amplified target nucleic acid sequences in the sample according to step d. of the second and third aspect and step f. of the third aspect reveals that the concentration of amplified target nucleic acids has increased above at least 10 pM, preferably above at least 50 pM and more preferably above at least 100 pM.

In a preferred embodiment of the third aspect of the present invention, the control probe comprises at least two different fluorescent labels. In preferred applications of this embodiment, fluorescent labels of the control probe are chosen such that they can be detected by fluorescence resonance energy transfer (FRET). In a further elaboration of these aspects of the present invention, the control probe with at least two different fluorescent labels is chosen such that it is degraded by the polymerase used in the polymerase chain reaction. Such a control probe may be a Taqman probe.

In a further preferred embodiment of the third aspect of the present invention, the control probe comprises at least one fluorescent label and one quenching label. Such probes may be selected from the group comprising a scorpion primer, a lux primer or a molecular beacon.

In a preferred embodiment relating to the first to third aspect of the present invention, the multitude of nucleic acid capture probes are capable of specifically binding to a plurality of different target nucleic acid sequences.

In a further preferred embodiment of the first to third aspect of the present invention, the multitude of nucleic acid capture probes are arranged on the substrate to form an array comprising spots with each spot comprising multiples of a nucleic acid capture probe of defined sequence.

In a further elaboration of such a preferred embodiment, some or all spots on the array differ from each other in that their nucleic acid capture probes are capable of specifically binding to different target nucleic acids.

In all of the aforementioned embodiments of the present invention, the dye capable of specifically interacting with double stranded nucleic acids may be an intercalating dye, preferably being selected from the group comprising SYBR Green 1, EtBr and Picogreen.

In another preferred embodiment of the aforementioned aspects of the present invention, detecting hybridization of amplified target nucleic acids with capture probes is done measuring signals at a distance of about 100 nm to about 300 nm from the surface of the substrate when using an evanescent wave detection scheme or within a distance of about 1 μm or less when using a confocal detection scheme.

In another preferred embodiment of the aforementioned aspects of the present invention, the signal generated by dyes being capable of specifically interacting with double stranded nucleic acids and which have bound to hybrids of amplified target nucleic acids with capture probes are measured during or after at least 2 thermal cycles, during or after at least 5 thermal cycles, during or after at least 10 thermal cycles, during or after 15 thermal cycles, during or after at least 20 thermal cycles or during or after at least 25 thermal cycles. In yet another preferred embodiment of the aforementioned aspects of the aforementioned aspects of the invention, thermocycling in step c. of the first and second and step d. of the third aspect of the invention comprises about 5 to 50 thermocycles.

### BRIEF DESCRIPTION OF THE DRAWINGS

FIG. 1 schematically depicts detection of target nucleic acids to capture probes. FIG. 1a) detects amplified single stranded target nucleic acids after denaturation of different identities (1t, 2t, and 3t), a dye (4) and nucleic acid capture probes of different identity (1p, 2p, 3p) which are immobilized on a substrate. FIG. 1b) shows that single stranded target nucleic acid sequences hybridize to the capture probes forming complexes denoted as 1pt, 2pt and 3pt with which dyes associate.

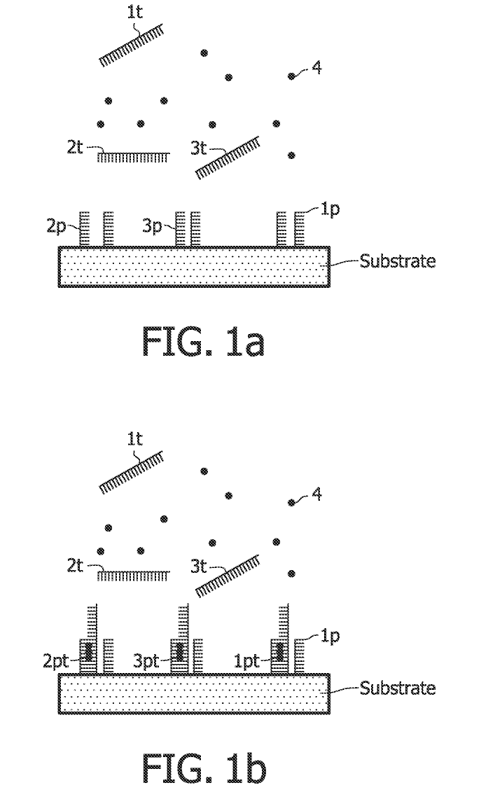

FIG. 2 depicts the reaction occurring during thermal cycling at an array-based PCR. FIG. 2a) depicts the elongation step in which labeled primers anneal to single stranded template DNA and become elongated. FIG. 2b) detects the denaturing step. Note that the double stranded template DNA being depicted in FIG. 2b) will become denatured, meaning that the two strands will disassociate. FIG. 2c) depicts the hybridization-annealing step. In this step, labeled primer will again associate with single stranded template DNA resulting from the previous denaturing step. Also, elongated target DNA will hybridize with the nucleic acid capture probes being immobilized on the array. In addition labeled primers will non-specifically adhere to the surface (not depicted).

FIG. 3 depicts a confocal scanning image of an array on a microscope slide after hybridization with the PCR fluid still on top of the slide. FIG. 3a) highlights the spot and background next to the spots with capture probes on which the bleaching experiment set out in Experiment 1 was performed. FIG. 3b) delineates the fluorescent signal during this bleaching experiment.

FIG. 4 shows a fluorescent image for SYBR Green 1 as used in Example 2. The scale of the image runs from white for low fluorescence intensities to red for high fluorescence intensities.

FIG. 5 depicts the threshold cycle number (Cycle number) as a function of input concentration (copies/microliter). The figure refers to Experiment 3.

FIG. 6 shows the signal intensity of the total bulk signal measured with an intercalating dye, the signal of the quality control assay and the signal of the target nucleic acids which are to be detected. The figure refers to Experiment 4.

FIG. 7 is a zoom-in of FIG. 6.

FIG. 8 depicts the threshold cycle number as a function of the total input DNA concentration. It refers to Experiment 5.

### DETAILED DESCRIPTION OF EMBODIMENTS

Before the present invention is described in detail below it is to be understood that this invention is not limited to the particular methodology, protocols and reagents described herein as these may vary. It is also to be understood that the terminology used herein is for the purpose of describing particular embodiments only and is not intended to limit the scope of the present invention which will be limited only by the appended claims. Unless defined otherwise, all technical and scientific terms used herein have the same meanings as commonly understood by one or ordinary skill in the art. The following definitions are introduced.

As used in this specification and in the intended claims, the singular forms of “a” and “an” also include the respective plurals unless the context clearly dictates otherwise.

It is to be understood that the term “comprise”, and variations such as “comprises” and “comprising” is not limiting. For the purpose of the present invention the term “consisting of” is considered to be a preferred embodiment of the term “comprising”. If hereinafter a group is defined to comprise at least a certain number of embodiments, this is meant to also encompass a group which preferably consists of these embodiments only.

The terms “nucleic acid” or “nucleic acid molecule” refer to a deoxyribonucleotide or ribonucleotide polymer in either single-or double-stranded form, and also encompass known analogues of natural nucleotides that can function in a similar manner as naturally occurring nucleotides.

The term “label” as used herein means a molecule or moiety having a property or characteristic which is capable of detection. Examples of labels are intercalating dyes, fluorophores, chemiluminophores, fluorescent microparticles and the like.

The term “target nucleic acid” refers to a nucleic acid, often derived from a biological sample, to which the nucleic acid capture probes on the substrate can specifically hybridize or can potentially hybridize. It is recognized that the target nucleic acids can be derived from essentially any source of nucleic acids (e.g., including, but not limited to chemical syntheses, amplification reactions, forensic samples, etc.) The presence or absence of one or more target nucleic acids may be detected, or the amount of one or more target nucleic acids may be quantified by the methods disclosed herein. Target nucleic acid(s) preferentially have nucleotide sequences that are complementary to the nucleic acid sequences of the corresponding capture probes to which they can specifically bind. However, with regard to cases where the presence or absence of one or more target nucleic is to be detected, the term “target nucleic” acids may also refer to nucleic acids present in a query sample that might potentially hybridize to the capture probes on the substrate.

A target nucleic acid may e.g. be a gene, DNA, cDNA, RNA, mRNA or fragments thereof.

The term “nucleic acid capture probe” as used herein refers to a specific oligonucleotide sequence which is capable of hybridizing to a target nucleic acid sequence due to its complementarity. Typically such nucleic acid capture probes will have a length of about 10 to about 1000 nucleotides, of about 10 to about 800 nucleotides, of about 10 to about 700 nucleotides, of about 10 to about 600 nucleotides, of about 10 to about 500 nucleotides, of about 15 to about 400 nucleotides, of about 15 to about 300 nucleotides, of about 15 to about 200 nucleotides, about 20 to about 150 nucleotides, about 20 to about 100 nucleotides, of about 20 to about 90 nucleotides, of about 20 to about 80 nucleotides, about 20 to about 70 nucleotides, about 20 to about 60 nucleotides or of about 20 to about 50 nucleotides. Typically, nucleic acid capture probe molecules will have a length of about 20, 30, 40, 50, 60, 70 nucleotides.

The term “multiplexing” as used herein refers to a process that allows for simultaneous amplification of many target nucleic acids of interest in one reaction by using more than one pair of primers. For example, said process might be Multiplex PCR.

The terms “background”, “background signal” or “background fluorescence” refer to signals resulting from non-specific binding, or other interactions, between target nucleic acids, capture probes or any other components, such as auto-fluorescent molecules or the substrate. Background signals may e.g. also be produced by intrinsic fluorescence of the substrate or its components themselves or by any unbound molecules being present in the solution on top of the substrate.

The term “amplicon” or “amplicons”, as used herein, refers the products of the amplification of nucleic acids, using e.g. PCR or any other method suitable for the amplification of nucleic acids. In one embodiment, the length of an amplicon is between 100 and 800 bases, preferably between 100 and 400 bases and more preferably between 100 and 200 bases.

If a nucleic acid capture probe or any other nucleic acid molecule described herein is said to be “specific” for a target nucleic acid or any other nucleotide sequence or to “specifically” bind to a target nucleic acid or any other nucleotide sequence this refers to preferential binding, duplexing, or hybridizing of said capture probe or any other nucleic acid molecule to a particular nucleotide sequence under stringent conditions. The term “stringent conditions” refers to conditions under which a probe will hybridize preferentially to its target sequence, and to a lesser extent to, or not at all to, other sequences. Stringent conditions are sequence-dependent and will be different in different circumstances.

Stringent conditions in this context may for example be selected to be about 5° C. lower than the thermal melting point (Tm) for the specific sequence at a defined ionic strength and pH. The Tm is the temperature (under defined ionic strength, pH, and nucleic acid concentration) at which 50% of the probes complementary to the target sequence hybridize to the target sequence at equilibrium. For example, stringent conditions may be those in which the salt concentration is at least about 0.01 to 1.0 M Na ion concentration (or other salts) at pH 7.0 to 8.3 and the temperature is at least about 30° C. for short probes (e.g., 10 to 50 nucleotides). Stringent conditions may also be achieved with the addition of destabilizing agents such as formamide.

The term “quantifying” as used herein with regard to nucleic acid abundances or concentrations may refer to absolute or to relative quantification. Absolute quantification may e.g. be accomplished by inclusion of known concentration(s) of one or more target nucleic acids (control nucleic acids) and referencing the signal intensity of target nucleic acids of unknown concentration with the target nucleic acids of known concentration (e.g. through generation of a standard curve). Relative quantification can be accomplished, for example, by comparison of signals between two or more target nucleic acids.

The term “dye that is capable of specifically interacting with a double stranded nucleic acid” refers to a label molecule that is capable of interacting with double stranded nucleic acids and gives a more intense signal, preferably a fluorescent signal than when being associated with single stranded nucleic acids or materials different from nucleic acids. Examples of such dyes are dyes that can intercalate into between the bases of double stranded nucleic acids such as DNA. Examples of such dyes comprise SYBR Green 1, EtBr, SYTOX Blue, SYTOX Green, SYTOX Orange, POP-1, BOBO-1, YOYO-1, TOTO-1, JOJO-1, POPO-2, LOLO-1, BOBO-1, YOYO-3, TOTO-3, PO-PRO-1, BO-PRO-1, TO-PRO-1, JO-PRO-1, PO-PRO-3, LO-PRO-1, BO-PRO-3, YO-PRO-3, TO-PRO-3, TO-PRO-5, SYTO 40 blue-fluorescent nucleic acid stain, SYTO 41 blue-fluorescent nucleic acid stain, SYTO 42 blue-fluorescent nucleic acid stain, SYTO 43 blue-fluorescent nucleic acid stain, SYTO 44 blue-fluorescent nucleic acid stain, SYTO 45 blue-fluorescent nucleic acid stain, SYTO 9 green-fluorescent nucleic acid stain, SYTO 10 green-fluorescent nucleic acid stain, SYTO 11 green-fluorescent nucleic acid stain, SYTO 12 green-fluorescent nucleic acid stain, SYTO 13 green-fluorescent nucleic acid stain, SYTO 14 green-fluorescent nucleic acid stain, SYTO 15 green-fluorescent nucleic acid stain, SYTO 16 green-fluorescent nucleic acid stain, SYTO 20 green-fluorescent nucleic acid stain, SYTO 21 green-fluorescent nucleic acid stain, SYTO 22 green-fluorescent nucleic acid stain, SYTO 23 green-fluorescent nucleic acid stain, SYTO 24 green-fluorescent nucleic acid stain, SYTO 25 green-fluorescent nucleic acid stain, SYTO 26 green-fluorescent nucleic acid stain, SYTO 27 green-fluorescent nucleic acid stain, SYTO BC green-fluorescent nucleic acid stain, SYTO 80 orange-fluorescent nucleic acid stain, SYTO 81 orange-fluorescent nucleic acid stain, SYTO 82 orange-fluorescent nucleic acid stain, SYTO 83 orange-fluorescent nucleic acid stain, SYTO 84 orange-fluorescent nucleic acid stain, SYTO 85 orange-fluorescent nucleic acid stain, SYTO 86 orange-fluorescent nucleic acid stain, SYTO 17 red-fluorescent nucleic acid stain, SYTO 59 red-fluorescent nucleic acid stain, SYTO 61 red-fluorescent nucleic acid stain, SYTO 17 red-fluorescent nucleic acid stain, SYTO 62 red-fluorescent nucleic acid stain, SYTO 63 red-fluorescent nucleic acid stain, SYTO 64 red-fluorescent nucleic acid stain, Acridine homodimer, Acridine orange, 7-AAD (7-amino-actinomycin D), Actinomycin D, ACMA, DAPI, Dihydroethidium, Ethidium Bromide, Ethidium homodimer-1 (EthD-1), Ethidium homodimer-2 (EthD-2), Ethidium monoazide, Hexidium iodide, Hoechst 33258 (bis-benzimide), Hoechst 33342, Hoechst 34580, Hydroxystibamidine, LDS 751 or Nuclear yellow. All these compounds are available e.g. from Invitrogen GmbH, Germany. Preferred dyes for the purposes of the present invention are SYBR Green 1 and picogreen.

As is known in the art, performing PCR reactions on an array on which capture probes are deposited can lead to significant background signals. Typically, for example, such PCR reactions are performed in the presence of fluorescently labeled primers. The amplicons are then hybridized with the immobilized capture probes and detected. However, if the PCR solution is not removed before hybridization, labeled primers which have not been extended may non-specifically absorb to the substrate of the array and thus lead to background signals.

The present invention to some degree lies in the finding that one can use dyes that can specifically interact with double stranded nucleic acid during array-based real time PCR, (i.e. multiplex real time PCR) and achieve a better signal to noise ratio than known for other methods. Without wanting to be bound by any scientific theory, it is assumed that using dyes that are capable of binding specifically to double stranded nucleic acids in view of their increased signal intensity when being bound to the nucleic acids allow for a better signal to noise ratio particularly if the signals of dyes that have bound to hybrids of amplified target nucleic acids and immobilized capture probes are measured close to the surface of the substrates on which the capture probes are immobilized.

The present invention in one aspect therefore relates to a method for monitoring the amplification of one or more target nucleic acids comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers
d. Hybridizing the denatured one or more target nucleic acids of step c.i. with the nucleic acids capture probes optionally concomitantly with the elongation step c.ii.;
e. Detecting hybridization of said one or more amplified target nucleic acids with said capture probes by determining a signal generated from the at least one dye that is capable of specifically interacting with double stranded nucleic acids.

Substrates used for the invention can be of any geometric shape. The substrate may e.g. be planar or spherical (e.g. a bead). It may e.g. be in the form of particles, strands, sheets, tubing, spheres, containers, capillaries, plates, microcopy-slides, beads, membranes, filters etc. In a preferred embodiment the substrate is planar and solid. In this context, solid means that the substrate is substantially incompressible. Suitable materials for the substrate include e.g. glass, plastic, nylon, silica, metal or polymers. In some embodiments the substrate might be magnetic.

In a preferred embodiment polymer and/or glass surfaces are used. Suitable polymers for the substrate are e.g. cyclic olefin polymer (COP) or cyclic olefin copolymer (COC).

Preferably, the substrate is thermally stable (e.g. up to 100° C.) such that it is able to endure the temperature conditions typically used in PCR. It is further preferred that the substrate is capable of being modified by attaching capture probes The capture probes are preferably immobilized on the surface of the substrate by covalent attachment.

Capture probes and/or the surface of the substrate may be modified with functional groups such as e.g. hydroxyl, carboxyl, phosphate, aldehyde or amino groups.

In some embodiments a chemical linker, linking the capture probes and the substrate, may be used for covalently attaching the capture probes to the substrate. For example, a thymine tail may be used as a linker in order to attach the nucleic acid capture probes to the substrate. A thymine tail may e.g. comprise about 2, 4, 6, 8, 10, 12, 14, 16, 18, 20 or more than 20 thymines. In a preferred embodiment a thymine linker comprises 16 thymines. In some preferred embodiments the linker may further comprise abasic sites located between the thymine tail and the capture probe. For example, the linker may comprise 1 to 20 abasic sites.

In general any nucleotide linker or any other suitable linker known to the skilled person can be used. In cases where a linker is used, the linker is preferably attached to the 5′ end of the capture probe.

Capture probes may alternatively be adsorbed on the surface of the substrate, provided that they remain stably attached to the surface under thermocycling conditions.

Capture probes can be single stranded oligonucleotide molecules, for example single stranded DNA or RNA molecules.

If the method according to the invention is used to monitor the amplification of a single target nucleic acid, all nucleic acid capture probes immobilized upon the surface of the substrate may be specific for the same target nucleic acid. However, the method according to the invention is preferably used for the detection of a plurality of different target nucleic acids. Thus, in a preferred embodiment the multitude of nucleic acid capture probes are capable of specifically binding to a plurality of different target nucleic acids.

In some embodiments, each individual capture probe immobilized upon the substrate may be specific for only one target nucleic acid. Alternatively, individual capture probes immobilized upon the substrate may be specific for more than one target nucleic acid.

For example, individual capture probes may be specific for various homologous sequences. A given nucleic acid capture probe may for example be specific for 1, 2, 3, 4, 5, 6, 7, 8, 9, 10, more than 10, more than 20, more than 30, more than 40 or more than 50 target nucleic acids. If a given capture probe is specific for more than 1 (i.e. several) target nucleic acids then it is preferred as described below that these target nucleic acids are similar.

If a capture probe is specifically binding a target nucleic acid, such as e.g. a gene, cDNA or RNA, then it is preferred that the capture probe specifically binds to the 5′- or 3′-end of an open reading frame of said target nucleic acid.

An open reading frame (ORF) is a portion of an mRNA, cDNA or a gene which is located between and includes the start codon (also called initiation codon) and the stop codon (also designated as termination codon) of said mRNA, cDNA or gene. One ORF typically encodes one protein. Thus, an ORF is part of the sequence that will be translated by the ribosomes into the corresponding protein.

For multiplexing it may be preferable to pattern the surface of the substrate, i.e. to locate immobilized capture probe to different regions on the substrate. Thus, in a preferred embodiment of the method of the invention the multitude of capture probe can be located to separate regions on the surface of the substrate. As used herein, “separate regions” or “spatial separation” refer to non-overlapping regions on the surface of the substrate. “Separate regions” can contact each other or can be arranged on the surface of the substrate such that they do not contact each other.

Preferably, separate regions are independently addressable regions, also referred to as “spots”. In a preferred embodiment, a spot comprises at least 1, 2, 3, 4, 5, 10, 20, 30, 40, 50, 60, 70, 80, 90, 100, 200, 300, 400, 500, 600, 700, 800, 900, 1000, 5000, 10000, 100000 or at least 1000000 capture probes. It is not required that each spot comprises the exact same number of capture probes but it is preferred that all spots comprise a similar number of capture probes such that upon measuring, the signal of all spots can be compared with each other. For example, the surface of the substrate may comprise multiple spots each of which consists of a sufficient number of capture probes that can be detected in the hybridization step.

In some embodiments the solid substrate may comprise about 1, 2, 3, 4, 5, 6, 7-10, 10-50, 50-100, 100-500, 500-1,000, 1,000-5,000, 5,000-10,000, 10,000-50,000, 50,000-100,000, 100,000-500,000, 500,000-1,000,000 or more than 1,000,000 spots.

In one embodiment, the substrate may comprise between 4 and 100000 spots per cm² and preferably between 20 and 1000 spots per cm².

Preferably, spots have a diameter of 50 to 250 μm. In further preferred embodiments spots may have a diameter of 50 to 90 μm, 90 to 120 μm, 120 to 150 μm , 150 to 180 μm, 180 to 200 μm, 200 to 220 μm or 220 to 250 μm.

It is further preferred that spots have a pitch of 100 to 500 μm. Spots may also have a pitch of 100 to 200 μm, 200 to 300 μm , 300 to 400 μm or 400 to 500 μm.

In a particular preferred embodiment spots have a diameter of 50 to 250 μm and a pitch of 100 to 500 μm. Most preferably, spots have a diameter of about 200 μm and a pitch of about 400 μm.

It is further preferred that in the method according to the invention the capture probes within each individual region are capable of specifically binding to the same or similar target nucleic acids. Two target nucleic acids are “similar” if they share at least 70%, 80%, 85%, 90%, 95%, 96%, 97%, 98%, 99% or 99.5% sequence identity. The determination of percent identity between two sequences is preferably accomplished using the mathematical algorithm of Karlin and Altschul (1993) Proc. Natl. Acad. Sci USA 90: 5873-5877. Such an algorithm is incorporated into the BLASTn and BLASTp programs of Altschul et al. (1990) J. Mol. Biol. 215: 403-410 available at NCBI (http://www.ncbi.nlm.nih.gov/blast/Blast.cge). The determination of percent identity is performed with the standard parameters of the BLASTn and BLASTp programs. If determining the percent identity between two sequences then it is preferred that the percent sequence identity is determined over the entire length of the shorter of the two sequences only.

In another preferred embodiment of the method, some or all regions on the substrate differ from each other in that their capture probes are capable of specifically binding to different target nucleic acids. Preferably 10%, 20%, 30%, 40%, 50%, 60%, 70%, 80%, 90%, or 100% of the regions on the substrate differ from each other in that their capture probes are capable of specifically binding to different target nucleic acids.

In a preferred embodiment the capture probes have their 5′-terminal ends attached to the substrate, such that their 3′-terminal ends are free to participate in primer extension reactions if e.g. incorporation of further labels is desired. Such labels may e.g. be fluorescently labeled nucleotides which allow for permanent labeling of the capture probes. The capture probes can be synthesized directly on the substrate or can be attached to the substrate post-synthetically. The capture probes may be deposited on the surface of the substrate e.g. by spotting or any other method comprised in the art known by the average skilled person. Thus, advantageously the manufacturing of the substrate requires no difficult, expensive or time consuming manufacturing steps but merely involves attaching the capture probes to the substrate. Furthermore manufactured substrates comprising said immobilized capture probes can easily be stored and exhibit a long shelf life. Furthermore, the manufactured substrate can be stored under dry conditions.

In step b) of the methods of the invention, one or more target nucleic acids and further reagents required for nucleic acid amplification (and optionally labeling) in a polymerase chain reaction process are added to the substrate. This serves to set up a nucleic acid amplification reaction.

The sample of one or more target nucleic acids according to b) may comprise one or more target nucleic acids to be detected or measured by the method of the invention.

In a preferred embodiment, the one or more target nucleic acid(s) in step b) comprise deoxyribonucleic acid(s) and/or ribonucleic acid(s).

If the nucleic acid sample according to b) comprises more than one target nucleic acids, the target nucleic acids may be derived from the same origin or from different origins, for example different biological specimens. The more than one target nucleic acids will typically comprise nucleic acids having different sequences. In a preferred embodiment the sample of one or more target nucleic acid(s) comprises nucleic acids whose sequences are complementary to one or more of the capture probes immobilized on the substrate. It is however not required that all target nucleic acids comprised in the sample are capable of binding to the capture probes comprised on the substrate. For example, the method according to the invention may in some embodiments be used for determining the presence or absence of a specific target nucleic acid in a sample. In such cases a query sample of one or more possible target nucleic acids may be added to the substrate in step b) in order to determine whether the sample comprises one or more nucleic acid targets of interest. If such nucleic acid targets are present in the sample, they will be capable of binding to the capture probes on the surface of the substrate. If however the query sample does not comprise any of the nucleic acid targets of interest or if the sample comprises a mixture of target nucleic acid(s) in question and additional nucleic acids of no particular interest, none or only some of the nucleic acids in the sample will bind to the capture probes comprised on the substrate.

One advantage of the method of the invention is that it is capable of multiplex analysis. For example, the sample of target nucleic acids may comprise 1, 2, 3, 4, 5, 6, 7, 8, 9, 10, more than 10, more than 20, more than 30, more than 40, more than 50, more than 60, more than 70, more than 80, more than 90, more than 100, more than 150, more than 200, more than 300, more than 400, more than 500, more than 1000, more than 5000, more than 10,000, more than 100,000 or more than 1,000,000 different target nucleic acids.

The one or more target nucleic acids may be of eukaryotic bacterial or viral origin.

In addition to the one or more target nucleic acids further reagents required for nucleic acid amplification (and optionally) labeling in a polymerase chain reaction process are added to the substrate. It is known to the skilled person, which reagents need to be added to a nucleic acid target in order to amplify said nucleic acid target.

Preferably, the reagents required for nucleic acid amplification (and optionally labeling) in b) are provided in solution, preferably in the form of a reaction mixture. It is further preferred that the substrate is in contact with the solution during amplification.

In a further preferred embodiment the reagents required for nucleic acid amplification (and optionally labeling) comprise an oligonucleotide primer pair or a plurality of different oligonucleotide primer pairs, nucleotides, at least one polymerase and optionally a detectable label. The reagents for nucleic acid amplification and labeling may further comprise a reaction buffer.

In an optional embodiment, the detectable label is a fluorescently labeled nucleotide. “Nucleotides” may be ribonucleotides or deoxyribonucleotides. Preferably, nucleotides are deoxyribonucleotides. If fluorescently labeled nucleotides are comprised in the reagents then they may be incorporated into extended immobilized capture probes during thermocycling. Thus, in a preferred embodiment, the immobilized capture probes get labeled with a fluorescent label during the extension step.

Suitable fluorescent labels may comprise e.g. Cyanine dyes, such as e.g. Cyanine 3, Cyanine 5 or Cyanine 7, Alexa Fluor dyes, such as e.g. Alexa 594, Alexa 488, Alexa 680, Alexa 532, fluorescein family dyes, Texas Red, Atto 655, Atto 680 and Rhodamine. In some embodiments the nucleotides may be labeled with two or more different dyes. In a preferred embodiment the nucleotides are labeled with only one dye. When using fluorescently labeled nucleotides a mixture of labeled and unlabelled nucleotides may be used. In one embodiment the unlabeled nucleotides are used in excess amount, i.e. in an amount which is greater than the amount of the fluorescently labeled nucleotides. Preferably at least three or four fold more unlabeled nucleotides are used than fluorescently labeled nucleotides.

As mentioned above, the reagents required for nucleic acid amplification and (optionally labeling) may comprise an oligonucleotide primer pair or a plurality of different oligonucleotide primer pairs. In cases where the reagents required for nucleic acid amplification and labeling comprise a plurality of different primer pairs, the different primer pairs are preferably specific for different target nucleic acids. The reagents might e.g. comprise 1, 2, 3, 4, 5, 6, 7, 8, 9, 10, more than 10, more than 20, more than 30, more than 40, more than 50, more than 60, more than 70, more than 80, more than 90, more than 100, more than 150, more than 200, more than 300, more than 400, more than 500, more than 1000, more than 5000, more than 10,000, more than 100,000 or more than 1,000,000 primer pairs.

The reagents required for nucleic acid amplification and labeling may comprise forward and/or reverse primers specific for said one or more target nucleic acids. If forward and reverse primers are comprised in the reagents, this will allow for a start-up reaction to occur in solution, generating amplicon(s).

The complementary strands of the amplicons are capable of annealing to the oligonucleotide primers during thermocycling in step c. of the first and second and step d. of the third aspect of the invention and thus provide additional copies of the target nucleic acids available for extension of said oligonucleotide primers.

The terms “forward primer” and “reverse” primer are used herein according to their conventional and well known meaning in the art.

The reagents required for nucleic acid amplification (and optionally labeling) may further comprise a DNA polymerase. In some embodiments the reagents may in addition to the DNA polymerase comprise a reverse transcriptase. A reverse transcriptase is preferably added when the one or more nucleic acid probe(s) in step b) comprises messenger RNA. Further details are set out below.

Amplification of the one or more target nucleic acids from step b) is achieved by a process involving thermocycling. The term thermocycling as used herein refers to a process comprising alternating heating and cooling of a reaction mixture allowing for amplification of one or more target nucleic acids. Alternating heating and cooling is repeated in several cycles, herein referred to as thermal cycles.

In some embodiments a thermal cycle may e.g. comprise 3 different temperature steps, which may e.g. comprise alternating from a first temperature step of from about 90° C. to about 100° C. (denaturing), to a second temperature step of from about 40° C. to about 75° C. (annealing), preferably from about 50° C. to about 70° C. to a third temperature step of from about 70° C. to 80° C., preferably about 72° C. to 75° C. (extension). Alternative forms of thermocycling are well known in the art and may comprise less or different temperature steps.

Preferably, thermocycling in step c. of the first and second aspect and step d. of the third aspect of the invention comprises more than 5 thermal cycles, more than 10 thermal cycles, more than 20 thermal cycles, more than 30 thermal cycles or more than 50 thermal cycles. Most preferably thermocycling comprises about 5 to 50 thermal cycles.

In a preferred embodiment the process involving thermocycling is polymerase chain reaction (PCR). PCR in addition to the aforementioned thermal cycles may further comprise a single initialization step comprising heating the reaction mixture to about 92° C. to 100° C. and/or a cooling step at about 4° C. after thermocycling has completed.

In some embodiments annealing of the one or more target nucleic acids to corresponding oligonucleotide primers may e.g. be achieved in a temperature step of from about 40° C. to about 75° C. and extension of the oligonucleotide primers may e.g. be achieved in a temperature step of from about 70° C. to 80° C., preferably about 72° C. to 75° C. as described above. In other embodiments annealing may take place at the same temperature as the extension.

Thermocycling is usually performed in a suitable apparatus, i.e. a thermal cycler.

In some embodiments it might be desirable to perform gene expression analysis, i.e. to determine the transcription levels of one or several different genes. In such cases a sample comprising mRNA transcript(s) of one or several genes of interest may be provided. The mRNA transcript(s) may then be reversed transcribed into cDNA. In some embodiments reverse transcription may be performed prior to the above thermocycling reaction in a separate reverse transcriptase PCR reaction. cDNA resulting from such a reaction may then serve as a target nucleic acid added to the substrate in step b).

In a preferred embodiment cDNA synthesis and the amplification step during thermocycling can be performed within the same reaction mixture. In these cases it is preferred that the one or more target nucleic acid(s) in step b) comprise messenger RNA and the further reagents required for nucleic acid amplification and labeling in addition to a DNA polymerase, such as e.g. Taq polymerase, comprise a reverse transcriptase.

If such an approach is used, it is preferred that the amplification process prior to the above described thermocycling comprises a single incubation step performed at about 40° C. to 60° C. allowing for cDNA synthesis. In one embodiment such an incubation step may be performed within 10 min to 45 min. In some embodiments the reaction may be incubated at about 20° C. to 25° C. prior to the cDNA synthesis step. Such an incubation step may e.g. be performed within 5 to 20 minutes.

Even though in one embodiment permanent labeling of the target nucleic acids and nucleic acid capture probes with e.g. fluorescent nucleotides is envisaged, it can be preferred that no permanent labeling (i.e. by covalent modification with a label) of target nucleic acids or capture probes is undertaken.

Hybridizing the double stranded one or more target nucleic acids obtained by thermocycling with the nucleic acid capture probes (see step d. of the first aspect, step e. of the second aspect and step f. of the third aspect of the invention) may be undertaken during the annealing step of the thermocycling reaction. Alternatively or in addition, the method in accordance with the invention may implement the hybridization step as an additional step. This may, e.g. be advisable in situations where the amplified target nucleic acid has a considerable longer length than the primers being used for the PCR reaction. In such a situation, hybridization of the amplified target sequence to the capture probe will differ with respect to its requirements from annealing of the primers to the PCR template sequences.

Detecting hybridization of the amplified target nucleic acid sequence with the capture probe molecules may be undertaken by different means. One problem that frequently occurs with signal detection is that it is often hampered by high background fluorescence. For example, high background fluorescence may be caused by unbound fluorescently labeled molecules such as, e.g., labeled nucleotides, labeled primers and/or labeled amplicons that are present in the reaction solution during thermocycling. This may render the measurement less sensitive.

Therefore, in one preferred embodiment a highly sensitive surface specific detection technology is used. Such a technology allows to limit the measurement to a small volume nearby the surface of the substrate and to detect labeled molecules on the surface of the substrate while largely avoiding detection of labeled molecules in solution, thus providing an improved signal-to-background ratio.

In one preferred embodiment detection of the signal is achieved by use of a confocal fluorescence scanner or an evanescence wave microcopy technology. An evanescent wave is a nearfield standing wave exhibiting exponential decay with distance. For example, total internal reflection fluorescence (TIRF) microscope can be used to measure the signal. In another preferred embodiment detection of the signal is achieved by use of a luminescence sensor. Such a device is e.g. described in WO 2007/010428, which is herewith incorporated by reference. Alternatively, the signal may e.g. be detected by use of a confocal microscope.

Thus, in a preferred embodiment, detecting hybridization is undertaken by measuring signals within a distance of about 100 nm to about 300 nm, preferably within 100 nm to 200 nm and most preferably within 100 nm to 150 nm from the surface of the substrate when using an evanescent detection scheme or within a distance of about 1 μm or less when using a confocal detection scheme.

By using dyes that specifically interact with double stranded nucleic acids, i.e. which have a higher signal intensity when being bound e.g. to double stranded DNA than when being bound to single stranded nucleic acids or being non-specifically bound to other molecular structures has the advantage that the background is reduced. This is particularly important as 75% of the background typically observed on array-based multiplex real time PCR reaction will result from DNA that is non-specifically bound to the surface of the array (see Experiment 2).

If the capture probes get additionally labeled during the thermocycling reaction, the signal to noise ratio may be improved even more. Detecting hybridization may then involve additional measuring the signal of the extended and labeled capture probes. The measurement may be taken during or after at least one thermal cycle.

Hybridization may be measured during or after at least 5 thermal cycles, during or after at least 10 thermal cycles, during or after least 15 thermal cycles, during or after at least 20 thermal cycles during or after at least 25 thermal cycles. It may also be measured during or after every thermal cycle.

The increase in the amount of nucleic acid is thus monitored as it is amplified, i.e. the increase in the amount of nucleic acid may is measured in “real time”.

“Real time measurement” may include detection of the kinetic production of signal, comprising taking a plurality of measurements in order to characterize the signal over a period of time. The fluorescence intensity for each amplification reaction may be determined using, e.g., a charge-coupled device (i.e. CCD camera or detector) or other suitable instrument capable of detecting the emission spectra for the label molecules used.

For each amplification reaction, the measured emission spectra obtained from the fluorescence samplings form an amplification data set. In some embodiments, it might be desirable to detect hybridization for each cycle in order to determine the presence or absence of one or more target nucleic acids in the sample, wherein the absence of the respective signal correlates with the absence of the respective target nucleic acid.

In other embodiments the amplification data set that may be processed for quantification, i.e. to determine the initial concentration of the one or more target nucleic acid(s). In some embodiments, the amplification data set may further comprise fluorescence intensity data obtained from one or more control nucleic acid targets whose initial target concentration is known, such as for example mRNA encoding the enzyme GAPDH. It is then possible to compare the signal intensity of target nucleic acids of unknown concentration with the target nucleic acids of known concentration, e.g. through generation of a standard curve.

For the purposes of the invention, the concentration of target nucleic acids being hybridized to capture probes and being determined by an evanescent detection scheme within less than 500 nm or by a confocal laser approach within less than 1 μm above the surface of the substrate is considered to be the “surface concentration”.

A computer may be used for data collection and processing. Data processing may e.g. be achieved by using suitable imaging software.

For further details on real-time PCR methodology and signal detection and quantification, reference can e.g. also be made to Dorak, M. Tevfik (ed.), Real-Time PCR, April 2006, Taylor & Francis; Routledge, 978-0-415-37734-8.

If an evanescent wave detection method is used the excitation wave will exhibit an exponential decay and, thus signals from which are further remote from the surface of the substrate (e.g. amplified target nucleic acids in the solution having incorporated the dye) will have a reduced emission signal. Alternatively, confocal (diffraction limited) detection can be used where only dyes are measured which are located within a distance of about 1 μm or less from the surface of the substrate.

In a particularly preferred embodiment of the first aspect of the invention which, however, also relates to the second and third aspect described hereinafter the capture probes may additionally being labeled with a fluorescent marker. This marker is selected such that it can interact with the dye being capable of interacting to double stranded nucleic acids to give Fluorescence Resonance Energy Transfer (FRET) effect when the dye has bound to double stranded nucleic acids, i.e. when the target nucleic acids have hybridized to the capture probes. The advantages of this embodiment will be illustrated with respect to the combination of Cy5 and SYBR Green 1, but the embodiment is not limited to this specific combination.

Capture probes are labeled with Cy5. Hybridization results in a double stranded duplex of the capture probes and the target molecules. The presence of an intercalating dye such as SYBR Green 1 (being green around 520 nm), which gives a substantially higher fluorescence signal nearby (when bound to) a double stranded fraction of DNA than elsewhere- and illumination with a blue excitation wavelength (e.g., between 440-490 nm) results in the excitation of an excited stated of SYBR Green 1. The energy of the excited state of SYBR Green 1 can efficiently be transferred to a Cy5 dye molecule by means of FRET. As FRET depends strongly on the distance between the Cy5 and SYBR Green 1 dye molecules, FRET essentially only occurs between a SYBR Green 1 molecule that is sufficiently close to the Cy5 dye label on the capture probe. The combined process (also referred to as iFRET) of excitation of the SYBR Green 1 dye molecule and the FRET between the SYBR Green 1 dye molecule and the Cy5 dye molecule, is only efficient for SYBR Green bound to a double stranded duplex of target DNA hybridized to a capture probe. The excited state of the Cy5 dye molecule created by iFRET results in a fluorescent signal in the red (with a peak around 660 nm), which is essentially only present for capture probes labeled with Cy5 and hybridized to target DNA. Both single stranded and double stranded a-specifically bound DNA and single and double stranded DNA in the bulk do essentially not result in a fluorescent peak in the red and can therefore easily be distinguished from target DNA hybridized with Cy5 labeled capture probes.

Another second aspect of the present invention relates to a method comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers;
d. Determining the concentration of the amplified target nucleic acids in the sample;
e. Hybridizing the denatured one or more target nucleic acids of step c.i. with the nucleic acids capture probes optionally concomitantly with the elongation step c.ii.;
f. Detecting hybridization of said one or more amplified target nucleic acids of step d. with said capture probes by determining a signal generated from the at least one dye that is capable of specifically interacting with double stranded nucleic acids.

All aspects that have been described above with respect to the first aspect of the invention, i.e. the nature of the substrates, the number of spots, the nature of the nucleic acid sequences, the thermocycling steps etc., hybridization and the detection thereof equally apply to the second aspect of the present invention. The second aspect of the present invention differs from the first aspect of the present invention that it includes an additional step in which the concentration of the amplified target nucleic acids in the sample is measured.

“Determining the concentration of the amplified target nucleic acids in the samples” according to the invention refers to the concentration of the amplified target nucleic acids in the PCR reaction above the capture probes, i.e. what is typically described as a “bulk concentration”. In contrast, the amount of amplified target nucleic acids hybridized to capture probes on the substrate is typically designated as the surface concentration (see above). Determining the amount of the amplified nucleic acid sequences in the sample provides the additional advantage that dependent on the determined concentration, it can be decided when to hybridize the denatured amplified target nucleic acids with the nucleic acid capture probes and/or when to start detecting hybridization of the amplified target nucleic acid to the capture probes.

Typically it is known for hybridization assays that the ratio between the concentration of capture probe/target nucleic acid duplexes and the capture probe concentration equals the product of the bulk concentration of amplified target nucleic acids and an association constant. Typical values for these association constants are in the order of 10⁵ l/s/M which implies that detection of hybridization in a reasonable time (such as a few minutes) will typically be feasible for concentrations of at least 1 nM.

For PCR reactions that are used for amplifying target nucleic acids of initially low concentration, conducting hybridization of the amplified target nucleic acids and the capture probe and detecting this hybridization after each thermocycle of the PCR reaction would thus in some cases unnecessarily expand the overall detection time for the array based real time PCR approach. Rather, it would be desirable to be in a position to start hybridization and/or detection of hybridization only once the amplified target nucleic acid concentration has reached a certain threshold level at which it could be expected that hybridization can be detected within a certain time frame (e.g. 5-10 minutes).

Therefore, methods in accordance with the present invention can include the additional step that the concentration of the amplified target nucleic acids is determined and that depending on this concentration, hybridization of the target nucleic acids with a capture probe will be initiated and/or detection thereof will be initiated.

The question of whether depending on the concentration measurement of the amplified target nucleic acid sequences in the sample hybridization (and/or detection thereof) should be initiated depends on the nature of the capture probes. If the capture probes are significantly different in terms of length and nucleotide composition from the primers used for amplification, it can be expected that the hybridization requirements will differ from the annealing requirements for the primers. In such a situation, it can make sense to postpone hybridization of the amplified target nucleic acid sequences with the capture probe nucleic acid sequences until determining the concentration of the target nucleic acid sequences in the sample has revealed that a certain threshold has been reached. If however, the capture probe nucleic acids and the primers used for PCR amplification are comparable in terms of hybridization requirements, hybridization will occur during the annealing step of the PCR reaction and the determination of the amplified target nucleic acid concentration in the sample may then be used to decide on the initiation of hybridization detection only.

One advantage of the second aspect of the present invention is that determining the concentration of target nucleic acid sequences in the sample, i.e. measuring the bulk concentration, and determining the concentration of target nucleic acid sequences hybridized to the capture probe nucleic acid sequences, i.e. the surface concentration can both be undertaken using the dyes capable of specifically interacting with double stranded nucleic acid sequences. Thus, it is not necessary to work with different dyes.

The person skilled in the art is well aware that determining the concentration of the amplified target nucleic acid sequences may include recording of a calibration curve which results from conducting the method in accordance with the second aspect of the invention with a known target nucleic acid sequence of defined concentration.

The threshold concentration which will trigger either hybridization and/or detecting hybridization of amplified target nucleic acid sequences with capture probes may be reached when the concentration of amplified target nucleic acids in the sample has increased above the detection limit for detecting hybridization.

Typically, the lower concentration limit for detecting hybridization of an amplifying target molecule with a capture probe molecule is typically at least 10 pM, at least 50 pM, at least 75 pM, at least 100 pM, at least 150 pM or at least 200 pM.

The third aspect of the present invention relates to a method comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Adding to said sample a double stranded nucleic acid of known identity and further reagents required for nucleic acid amplification in a polymerase chain reaction including forward and reverse primers and a control probe which allows fluorescent detection at wavelengths different from the dye that is capable of specifically interacting with double stranded nucleic acids, with the primers and the control probe being specific for said double stranded nucleic acid of known identity;
d. Amplifying the one or more target nucleic acids and the double stranded nucleic acid of known identity by a process involving thermocycling, comprising the steps of:

i. Denaturing the one or more target nucleic acids;

ii Annealing the forward and reverse primers with the respective strands of the denatured strands of the one or more target nucleic acids;

iii. Elongating the annealed forward and reverses primers;
e. Determining the concentration of the amplified target nucleic acids in the sample;
f. Hybridizing the denatured one or more target nucleic acids of step d.i. with the nucleic acids capture probes optionally concomitantly with the elongation step d.ii.;
g. Detecting hybridization of said one or more amplified target nucleic acids of step d. with said capture probes by determining a signal generated from the at least one dye that is capable of specifically interacting with double stranded nucleic acids.

All aspects that have been described above with respect to the first and second aspect of the invention, i.e. the nature of the substrates, the number of spots, the nature of the nucleic acid sequences, the thermocycling steps etc., hybridization and the detection thereof equally apply to the third aspect of the present invention.

This third aspect of the present invention is a further elaboration of the second aspect of the present invention and the first aspect of the present invention. Using dyes being capable of specifically binding to double stranded nucleic acids allow e.g. reducing the background due to non-specific interaction with the surface of the substrates. Determining the concentration of the amplified target nucleic acids in the sample allows postponement of initiation of hybridization and/or detection of hybridization of amplified target nucleic acid sequences to capture probes to a point in time where it can be expected that there will be sufficient target nucleic acid sequence to be detected at the capture probes. The third aspect of the present in invention comprises, however, the additional step that one adds to the PCR reaction a double stranded nucleic acid of known identity (positive control target nucleic acid sequence) and a control probe which allows detection of the amplified control nucleic acid sequence at wavelengths different from the dye that is capable of specifically interacting with double stranded nucleic acids.

The inclusion of such an internal control allows inter alia checking that the PCR reaction as such has worked. Moreover, as is shown in the Examples, the signal obtained from the dye being capable of specifically interacting with double stranded nucleic acids can nevertheless be used to determine the bulk concentration of amplified target nucleic acid sequences.

In addition, the control probe used in the third aspect of the present invention may comprise at least two different fluorescent labels. These labels may be chosen such that they can be detected by a fluorescent resonance energy transfer (FRET).

As mentioned above, in a particularly preferred embodiment of the second and third aspect of the invention, the capture probes may additionally be labeled with a fluorescent marker. This marker is selected such that it can interact with the dye being capable of interacting to double stranded nucleic acids to give Fluorescence Resonance Energy Transfer (FRET) effect when the dye has bound to double stranded nucleic acids, i.e. when the target nucleic acids have hybridized to the capture probes. The advantages of this embodiment have been illustrated with respect to the combination of Cy5 and SYBR Green 1, but the embodiment is not limited to this specific combination.

For the second and third aspect, the intercalating SYBR Green 1 dye can be also used for monitoring the PCR reaction in bulk and the red fluorescent signal of Cy5 can be used for detection the amount of hybridized DNA on a spot with capture probes specific for a certain target.

Particularly preferred are probes which comprise at least two different fluorescent labels that can be detected by FRET and where the probe gets degraded by the polymerase used in the polymerase chain reactions. Such types of probes are typically designated as so called “Taqmanprobes”. The Taqman probes hybridize with the target nucleic acid sequences; however, upon the primer extension during PCR, the Taqman probe degrades which destroys the FRET signal. Given that the fluorescent labels of the control probes emit light in a different wavelength than the dye that is capable of specifically binding with double stranded nucleic acid sequences, the PCR reaction on a control target nucleic acid can be followed by two signals, namely the incorporation of the dye and the destruction of e.g. the Taqman probe. The dye in addition will incorporate into the double stranded nucleic acids resulting from different target nucleic acid sequence amplification. As a consequence, the signal generated from the dye will refer to the unknown target nucleic acid sequences as well as the control target nucleic acid sequence, whilst the signal generated by the control probes such as the e.g. Taqman probe, will refer only to the control target nucleic acid sequence.

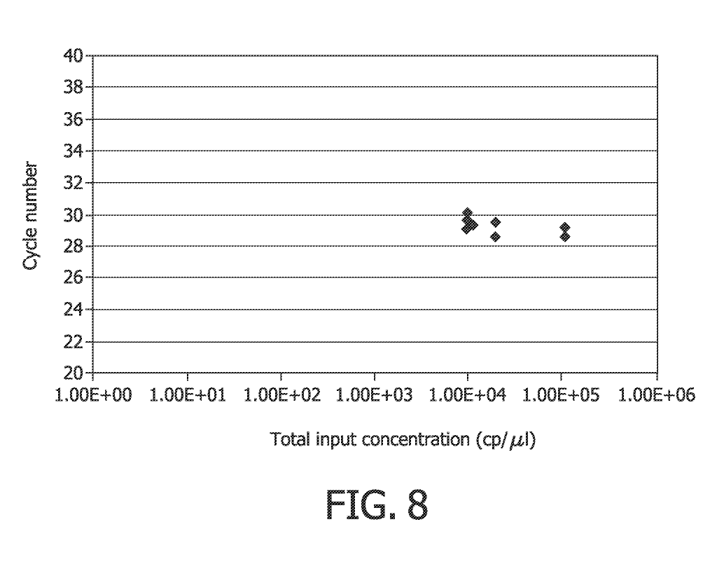

As is shown in Experiment 5 (see FIGS. 8 and 9), the threshold concentration determined from the control probe signal can be correlated with a corresponding signal generated from the dye. If the overall signal from the dye is then corrected for the dye signal resulting from the control nucleic acid sequence, one obtains a concentration of the target nucleic acid sequences in the sample, i.e. the target nucleic acid sequence bulk concentration, and can decide on the hybridization and/or detection of hybridization of target nucleic acid sequences with capture probes depending on this concentration.

The person skilled in the art will understand that other control probes may serve the same purpose. Thus, control probes may comprise at least one fluorescent label and one quenching label such as they are used in scorpion primers, Lux primers or molecular beacons. Such probes, in some instances, are also described as Taqman probes.

The invention is described hereinafter in terms of experiments which relate to some of the preferred embodiments of the present invention. These experiments are not to be construed as limiting the invention in any way.

### Experiment 1

In the following experiment, the effects of background signaling are depicted.

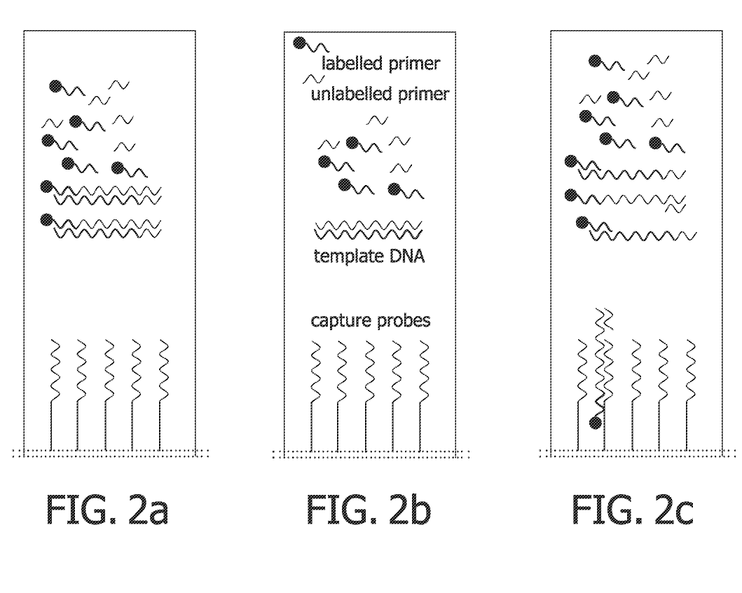

FIG. 2 depicts schematically the steps undertaken when performing an array-based PCR with e.g. primers which comprise a fluorescent label for a DNA target sequence. a) depicts the elongation step, b) depicts the denaturation step and c) annealing/hybridization step. During step c), the primers will anneal with the single stranded DNA, whereas the amplicons will hybridize to the capture probes. In addition, primers and/or amplicons will bind non-specifically to e.g. the array outside the capture probe spots leading to a background signal (not depicted).

An experiment was conducted to determine the extent and nature of such background signals.

First a standard PCR was performed with a target double stranded DNA and unlabeled forward primer and Cy5 labeled reverse primer. The obtained PCR product was diluted to a final end concentration of 5 nM in a 1× mastermix.

In parallel capture probes exactly complementary to the target sequence of sequence were deposited on a Superamine 2 ArrayIt microscope glass slide. The capture probes were provided with a 16 thymine tail attached to the 5′-end. After printing, they were provided with 400 mJ/cm² 254 nm UV exposure and subsequently the excess of probes was washed away using 5×SSC, 0.1% SDS and 0.1 mg/ml herring sperm DNA. After that, the slides were briefly rinsed with water and dried for 30 minutes in an oven.

Subsequently the PCR sample was hybridized in the PCR buffer with the capture probes at 46° C. during one hour.

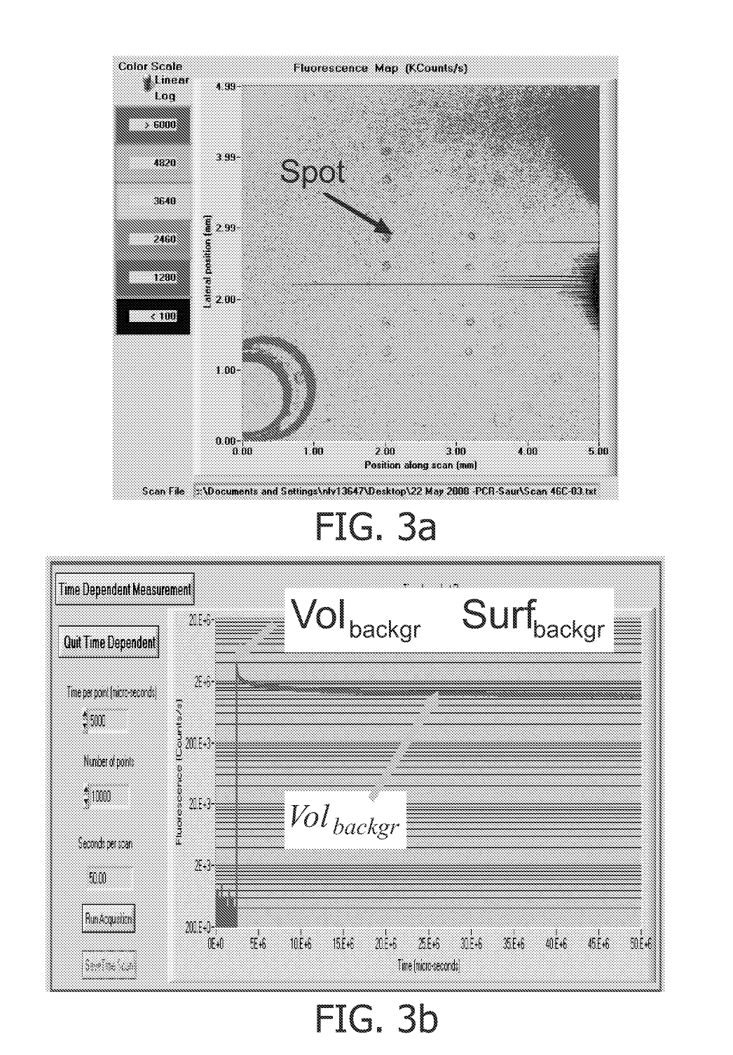

Signal detection was undertaken with confocal scanning FIG. 3a) depicts the signals generated by the capture probe spots and background signals surrounding these spots.

A bleaching experiment was then conducted to determine the nature of the background where the location of the optical spot was fixed. The fluorescence signal was then measured as a function of time for this spot.

The rationale of this experiment is that the fluorescently labeled primers, which are non-specifically immobilized on the microscope slide (so called surface background) and which are in the focus of the spot during the whole measurement, will bleach, while labeled primers in solution will be in the focus of the spot only for a very short time (so called volume background) and are continuously replenished due to diffusion. The background signal caused by these diffusible labeled primers will thus not permanently bleach. As a consequence, the fluorescent signal just after measuring the spot is proportional to the sum of surface and volume background, while the base-line of the bleaching curve corresponds with the volume background only.

From this experiment it was determined that ¾ of the background signal is surface background (see FIG. 3b)).

### Experiment 2

The following experiment was conducted to show that dyes being specific for double stranded nucleic acids give low background signals due to non-specific binding of dye and/or nucleic acids not hybridized to capture probes to the substrate surface.

An array of spots with capture probes of two types was printed on an ArrayIt amino modified glass substrate. One capture probe had the sequence 5′-ACTTTTACTGGAGTCGTCGA-3′ (SEQ ID No.: 1) and the other capture probe had the sequence 5′-TTTTTTTTTTTTTTTTAAGGCACGCTGATATGTAGGTGA-3′ (SEQ ID No.: 2). The latter sequence served as a negative control.

On this array, 10 nM of sequence 5′-TCGACGACTCCAGTAAAAGT-3′ (SEQ ID No.: 3), that is perfectly complementary to the first capture probe were hybridized. Because of the setup of this experiment, there was no double stranded DNA in the fluid on top of the array, and it was expected that differences in the signal between spots and background are due to differences of the dye in the specificity for dsDNA over ssDNA. In order to simulate a worst case scenario, hybridization was performed at room temperatures where one would expect non-specific surface background to be the highest. The hybridization conditions were overnight at room temperature.

In both experiments, a scanning confocal microscope was used to ensure surface specific detection. For the experiments with SYBR Green 1, an Ar-laser line at 488 nm was used as excitation source. Fluorescence was detected for a wavelength interval between 500-600 nm.

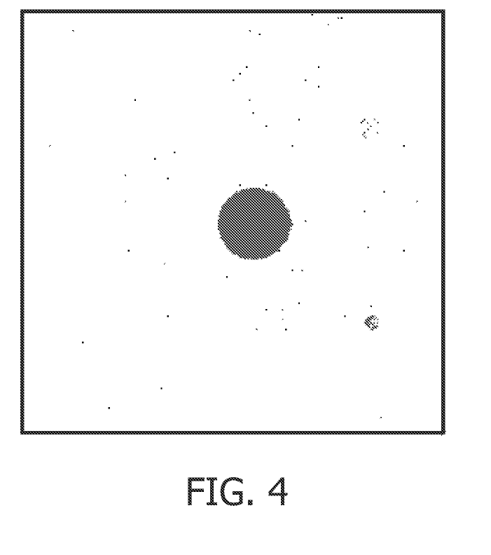

FIG. 4 shows an example for the spot of SEQ ID No. 1 and SYBR Green 1 dye, after overnight hybridization at room temperatures. Contrast values between the spot and the background better than a factor 1000 were observed, which clearly indicates that the non-specific binding of SEQ ID No. 3 at the binding surface gives only a very small contribution to the fluorescent signal.

The fluorescent signals were also compared with the negative controls (i.e. SEQ ID No.: 2), from which it was concluded that the fluorescent signal of the hybridized spots is about a factor 16 higher than the fluorescent signal of the negative controls. The fluorescence of the negative control is mainly attributed to non-specific binding of SEQ ID No. 3 to the E. coli capture probes (i.e. SEQ ID No. 2).

### Experiment 3

The following experiment demonstrates that a dye that is capable of specifically interacting with double stranded nucleic acids such as the intercalating dye SYBR Green 1 can be used to determine bulk concentrations of amplified target nucleic acids.

An experiment was done by using two target sequences using different primer pairs for both targets. 300 nM of forward and reverse primers were included. For one of the targets, 200 nM Taqman probe was included. This Taqman probe has a fluorescent reporter (Yakima yellow) attached to the 5-end and a quencher (Black hole quencher 1) attached to the 3-end. Different amounts of input template concentrations were used. PCR was done on a thermocycler, where both the signals of the SYBR green as well as the Yakima yellow were measured.

Three different approaches were used for real-time PCR detection:
1. Adding and measuring only SYBR green in a single well
2. Adding and measuring only Taqman probe with Yakima-yellow (YY) in a single well.
3. Adding and measuring both SYBR green as well as Taqman with Yakima-yellow (from the same well) in a single well

Signals were recorded during PCR using the commercially available thermocycler 7300 of Applied Biosystems and the SDS software implemented thereon. The threshold level was set as suggested by the software. For determining the concentration, the following calibration experiment were performed.

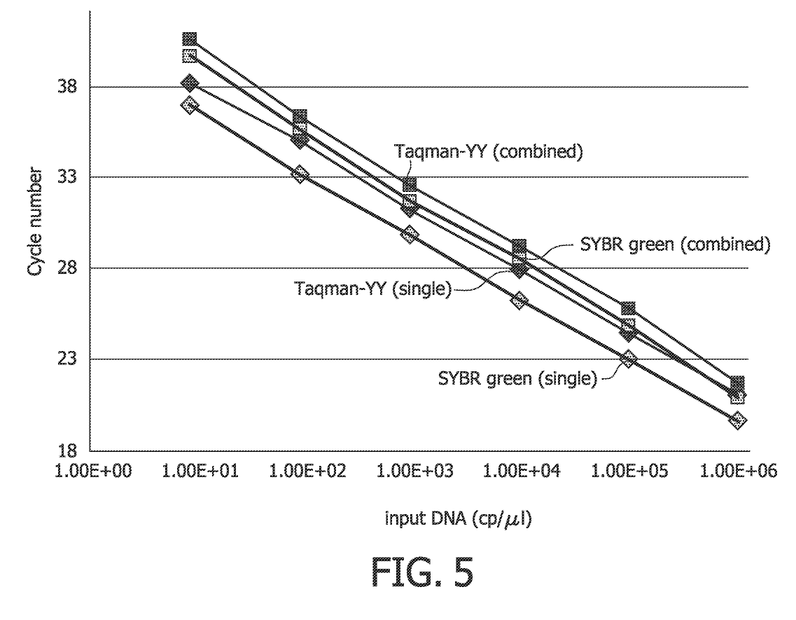

FIG. 5 gives the threshold cycle number as a function of input concentrations. From the experiments where either only SYBR Green 1 or only YY were used for detection, it can be seen that the threshold cycle number (Ct) for the SYBR Green 1 is slightly lower (1.5 cycles) than for the YY detection. The signals obtained when both the SYBR Green 1 and the YY-Taqman probe were added to the PCR reaction (“combined”) give the results of the individual dyes in the mixture.

Comparing the single with the combined experiments, one can conclude that the interference between the YY-Taqman probe and SYBR Green 1 is small. The Ct of the SYBR Green 1 signal increases with around 2.0, whereas the Ct of the YY signal increases with 1.3. These numbers are not dependent on the input DNA concentration, meaning that it is possible to correct for this.

Thus, there is a constant difference between the Ct of SYBR Green 1 and YY, which can be corrected for. There is limited influence of the dyes on each other.

Given that both labels give similar results, it is clear that one can use dyes which are specific for double stranded nucleic acids such as intercalating dyes in order to measure bulk amplified target nucleic acid concentrations.

### Hypothetical Experiment 4

This hypothetical experiment illustrates how a control probe which allows fluorescent detection at wavelengths different from the dye that is capable of specifically interacting with double stranded nucleic acids can be used to determine when detecting hybridization at the capture probes should begin.

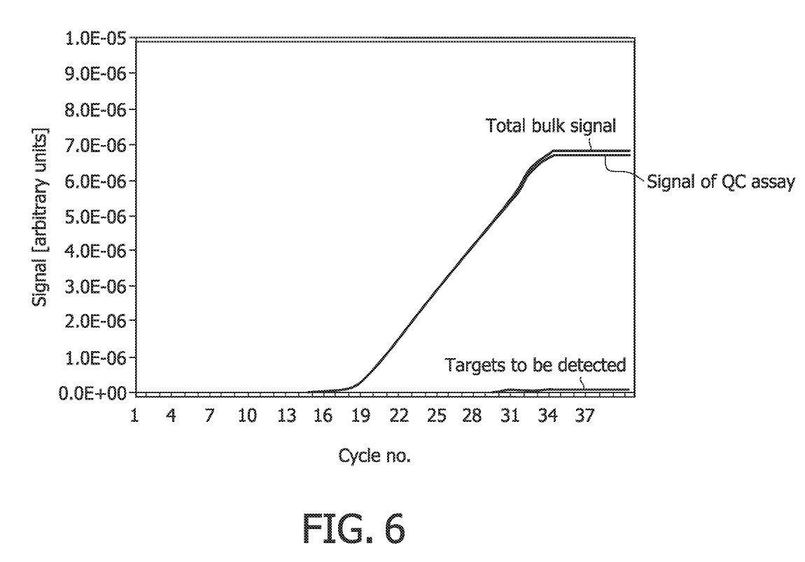

FIG. 6 illustrates this hypothetical example. In this case, an example is given for a PCR curve of high input concentrations (10⁶ cp/μl) for a double stranded nucleic acid of known identity (control nucleic acid, this reaction is called quality control (QC) assay) and low input of a target nucleic acid (10² cp/μl).

In the line designated “Total bulk signal”, the overall signal of the intercalating dye SYBR-Green 1 is given, which can be measured. This signal is the sum of the amplified target and the control nucleic acid. The total concentration of the control nucleic acid only can be specifically measured by a Taqman probe (“Signal of QC assay”) which can be detected at different wavelengths compared to SYBR Green 1. Then, the signal of the target nucleic acids only can be obtained by correcting the signal of both the target and control nucleic acids (“Total bulk signal”) with the signal of the control nucleic acid (“Signal of QC assay”), leading to the signal designated (“Targets to be detected”). The absolute concentrations are determined using proper calibration procedures.

This information can then be used to specify the moment of using surface specific detection. Hybridization of the amplicons to the capture probes is relatively slow. If surface specific detection can only be done at concentrations above the detection limit, the PCR can be as fast as possible (leaving out the surface specific detection below the detection limit). By bulk detection, the concentration of the targets can be measured and it can then be concluded when the concentration is above the detection limit. At the same time the quality control assay provides an independent read-out that the PCR reaction has indeed worked.

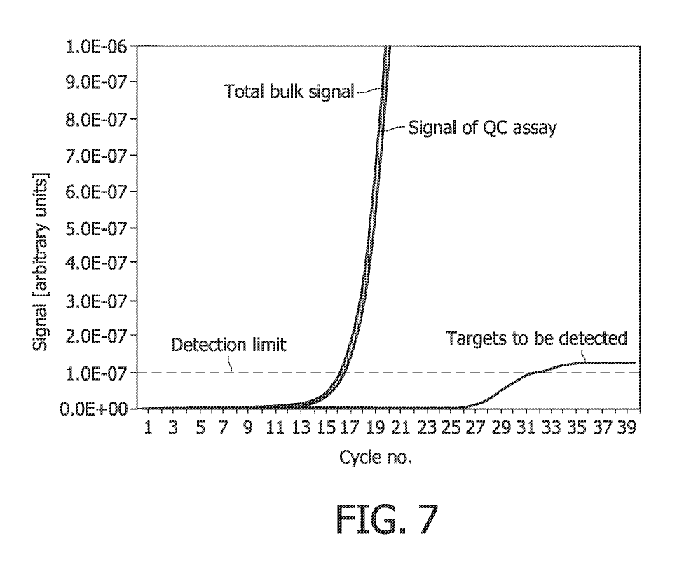

FIG. 7 is a zoom-in of FIG. 6.

A theoretical detection limit of 10⁻⁷ arbitrary units is given. The overall bulk signal (target and control nucleic acids) reaches the detection limit around cycle 17. However, the target nucleic acid concentration only reaches the detection limit around cycle 31. This would mean that based on the bulk signal, surface specific detection is started at cycle 18. However, it takes an additional 13 cycles before the targets really give detectable signal on the spots on the surface (microarray). Therefore, if this decision would be based on the corrected signal (“Targets to be detected”), only after 31 signals, the surface specific detection is started. This considerably reduces the time for the overall PCR/hybridization. If one assumes that a typical hybridization/detection measurement takes 5 minutes, this implies a reduction in the time of the overall real-time array PCR reaction of 70 minutes (31−17=14 cycles of around 5 minutes per hybridization/detection, =70 minutes).

### Experiment 5

In order to prove the use of an internal control, the following experiment was performed.

A two-plex PCR with specific primers for each target was performed. One input DNA represents the internal control (used with always the same input concentration, which is 10⁴ copies/μl. The other input DNA represents the targets (in input concentrations varying from 10¹-10⁵ cp/μl). For detection of the amplified internal control, a Taqman probe with Yakima Yellow-dye and a quencher was included in the sample. Both, the amplified internal control and the amplified target DNA were measured with SYBR Green 1.

FIG. 8 gives the results measured for YY. Again, the threshold cycle number was determined as set out above. It is clear that there is no correlation between total (i.e. internal and target input DNA) input concentration and threshold cycle number for the internal control. This means that the internal control will have the same cycle number, which means it can be used as an internal control of the PCR.

The experiment shows that inclusion of an internal control does not alter the shape of signal curves when using dyes specific for double stranded nucleic acids, e.g. intercalating dyes such as SYBR Green-1. This means that one can use a control target sequence to ensure PCR efficiency and at the same time use the signal form the dye to determine the concentrations of the target nucleic acids only by correcting for the signal generated by a control probe.

1. Method for monitoring the amplification of one or more target nucleic acids comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:
i. Denaturing the one or more target nucleic acids;
ii. Annealing the forward and reverse primers with the respective strands of the denatured strands of the one or more target nucleic acids;
iii. Elongating the annealed forward and reverses primers
d. Hybridizing the denatured one or more target nucleic acids of step c.i. with the nucleic acids capture probes optionally concomitantly with the elongation step c.ii.;
e. Detecting hybridization of said one or more amplified target nucleic acids with said capture probes by determining a signal generated from the at least one dye that is capable of specifically interacting with double stranded nucleic acids.

2. Method according to claim 1 comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Amplifying the one or more target nucleic acids by a process involving thermocycling, comprising the steps of:
i. Denaturing the one or more target nucleic acids;
ii. Annealing the forward and reverse primers with the respective strands of the denatured strands of the one or more target nucleic acids;
iii. Elongating the annealed forward and reverses primers;
d. Determining the concentration of the amplified target nucleic acids in the sample;
e. Hybridizing the denatured one or more target nucleic acids of step c.i. with the nucleic acids capture probes optionally concomitantly with the elongation step c.ii.;
f. Detecting hybridization of said one or more amplified target nucleic acids of step d. with said capture probes by determining a signal generated from the at least one dye that is capable of specifically interacting with double stranded nucleic acids.

3. Method according to claim 2 comprising the following steps:
a. Providing a substrate having immobilized on its surface a multitude of nucleic acid capture probes each being complementary to a target nucleic acid with nucleic acid capture probes of different identity being spatially separated from each other;
b. Adding to said substrate a sample of one or more target nucleic acids and further reagents required for nucleic acid amplification in a polymerase chain reaction including forward and reverse primers and at least one dye that is capable of specifically interacting with double stranded nucleic acids;
c. Adding to said sample a double stranded nucleic acid of known identity and further reagents required for nucleic acid amplification in a polymerase chain reaction including forward and reverse primers and a control probe which allows fluorescent detection at wavelengths different from the dye that is capable of specifically interacting with double stranded nucleic acids, with the primers and the control probe being specific for said double stranded nucleic acid of known identity;
d. Amplifying the one or more target nucleic acids and the double stranded nucleic acid of known identity by a process involving thermocycling, comprising the steps of:
i. Denaturing the one or more target nucleic acids;
ii. Annealing the forward and reverse primers with the respective strands of the denatured strands of the one or more target nucleic acids;
iii. Elongating the annealed forward and reverses primers;
e. Determining the concentration of the amplified target nucleic acids in the sample;
f. Hybridizing the denatured one or more target nucleic acids of step d.i. with the nucleic acids capture probes optionally concomitantly with the elongation step d.ii.;
g. Detecting hybridization of said one or more amplified target nucleic acids of step d. with said capture probes by determining a signal generated from the at least one dye that is capable of specifically interacting with double stranded nucleic acids.

4. Method according to claim 2, wherein determining the concentration of the amplified target nucleic acid sequences in the sample includes recording of a calibration curve that results from conducting the methods of claim 2 or 3 with a known target nucleic acid sequence of defined concentration.

5. Method according to claim 2, wherein detecting hybridization is undertaken if determining the concentration of the amplified target nucleic acid sequences in the sample reveals that the concentration of amplified target nucleic acids has increased above the detection limit for detecting hybridization.

6. Method according to claim 5, wherein detecting hybridization is undertaken if determining the concentration of the amplified target nucleic acid sequences in the samples reveals that the concentration of amplified target nucleic acids has increased above at least 50 pM.

7. Method according to claim 3, wherein the control probe comprises at least two different fluorescent labels.

8. Method according to claim 7 the fluorescent labels of the control probe with at least two different fluorescent labels are chosen such that they can be detected by Fluorescence Resonance Energy Transfer.

9. Method according to claim 8, wherein the control probe with at least two different fluorescent labels is chosen such that it gets degraded by the polymerase used in the polymerase chain reaction.

10. Method according to claim 9, wherein said control probe is a TaqMan probe.

11. Method according to claim 3, wherein the control probe comprises at least one fluorescent label and one quenching label.

12. Method according to claim 11 wherein said control probe is selected from the group comprising a scorpion primer, a lux primer molecular beacon, or a taqman probe.

13. Method according to claim 1, wherein said substrate is an array of nucleic acid capture probes.

14. Method according to, wherein determining the concentration of target nucleic acids being hybridized to capture probes is done using a confocal laser microscope, an evanescent wave approach,

15. Method according to claim 1 wherein the capture probes are labeled with a fluorescent label such that this label can undergo FRET with the dye being capable of specifically binding to double stranded nucleic acids once the dye has bound to a hybrid of a target nucleic acid and a capture probe.


SEQUENCE LISTING (3 sequences)

SEQ ID NO: 1 - DNA, 20 bp, unknown
  test sequence
acttttactggagtcgtcga

SEQ ID NO: 2 - DNA, 39 bp, unknown
  test sequence
ttttttttttttttttaaggcacgctgatatgtaggtga

SEQ ID NO: 3 - DNA, 20 bp, unknown
  test sequence
tcgacgactccagtaaaagt